(19) United States
(12) Patent Application Publication
(10) Pub. No.: US 2026/0195684 A1
(43) Pub. Date: Jul. 9, 2026

(54) Adaptive Supplier Risk Scoring System for Supply Chain Management

(71) Applicants: Gennaro Anthony Cuomo, Raleigh, NC (US); Mohan Venkataraman, Cary, NC (US); Srivats Gopinath, Spring Hill, TN (US); Palghat Krishnan Sridhar, Morrisville, NC (US); Shyam Adivi, Apex, NC (US); Sai Nidamarty, Cary, NC (US)

(72) Inventors: Gennaro Anthony Cuomo, Raleigh, NC (US); Mohan Venkataraman, Cary, NC (US); Srivats Gopinath, Spring Hill, TN (US); Palghat Krishnan Sridhar, Morrisville, NC (US); Shyam Adivi, Apex, NC (US); Sai Nidamarty, Cary, NC (US)

(73) Assignee: Chainyard Supplier Management Inc, Morrisville, NC (US)

(21) Appl. No.: 19/187,487

(22) Filed: Apr. 23, 2025

Related U.S. Application Data
(60) Provisional application No. 63/742,453, filed on Jan. 7, 2025.

(51) Int. Cl. G06Q 10/0635; G06Q 10/0639

(52) U.S. Cl. CPC G06Q 10/0635; G06Q 10/06393

(57) ABSTRACT

An adaptive supplier risk evaluation system is disclosed, comprising data processing, dynamic risk categorization, and predictive scoring for real-time supplier risk assessment. The system aggregates structured, unstructured, and real-time data, including financial metrics, compliance records, ESG reports, social media sentiment, and geopolitical event feeds, into enriched supplier profiles. Machine learning models analyze risk dimensions such as financial stability, operational performance, ESG compliance, and cybersecurity. Dimension-specific scores are computed and aggregated into a composite supplier risk score, dynamically adjusted based on updated data and organizational priorities. Risk evaluations are stored in a centralized repository for real-time access, supporting decision-making, auditability, and explainability. The system is modular and scalable, providing adaptive risk management across industries including manufacturing, healthcare, and logistics.

### CROSS-REFERENCE TO RELATED APPLICATIONS

This application claims the benefit of priority under 35 U.S.C. § 119(e) to U.S. Provisional Patent Application No. 63/742,453, filed on Jan. 7, 2025, entitled “Adaptive Supplier Risk Scoring System for Supply Chain Management”, the entire contents of which are hereby incorporated by reference.

### BACKGROUND OF THE INVENTION

### Field of the Invention

The present invention relates to artificial intelligence in supply chain management, and more specifically to systems and methods for adaptive supplier risk evaluation based on dynamic data integration, machine learning, and predictive analytics.

### Description of the Related Art

Existing supplier risk management systems are typically based on static, rule-driven scoring models that rely on structured data sources such as financial statements and compliance records. These models offer limited flexibility, requiring frequent manual updates, and generally fail to reflect emerging risks in a timely manner. While some systems include basic automation, they remain reactive and do not adapt effectively to evolving supply chain conditions.

Traditional approaches often neglect unstructured and real-time data sources, including news feeds, social media sentiment, and geopolitical developments, which are essential for identifying new and unforeseen risks. As a result, predictive capabilities in these systems are constrained by fixed models that do not dynamically adjust to changing contexts. Moreover, the lack of transparency in scoring methodologies can undermine trust, particularly in industries where regulatory compliance and accountability are paramount.

In modern, complex supply chains, organizations require real-time, adaptive risk assessments to prevent operational disruptions, financial losses, and compliance failures. Current solutions generally do not support the integration of diverse data sources or provide actionable, context-aware insights. Consequently, organizations are often left responding to risks after they materialize, rather than proactively mitigating them.

Users impacted by these limitations include procurement managers, supply chain analysts, compliance officers, and executives across industries such as manufacturing, retail, healthcare, and technology. These professionals depend on accurate, timely, and explainable risk assessments to ensure continuity, manage financial exposure, and meet regulatory requirements.

Integrating diverse data sources, including structured metrics and unstructured, real-time inputs, presents substantial technical challenges. Structured data can be processed through established methods, but unstructured data—such as news articles, social media posts, and live event streams—requires advanced natural language processing for entity extraction, sentiment analysis, and contextual interpretation. Additionally, reconciling data inconsistencies, resolving ambiguities, and maintaining consistency amid frequent updates add complexity. Accurately modeling non-linear relationships across heterogeneous datasets further complicates supplier risk evaluation.

These challenges highlight the need for a more comprehensive and adaptive approach to supplier risk management, capable of real-time data integration, contextual risk classification, and predictive analytics that evolve with changing supply chain conditions.

### Comparison to Related Art

Several existing systems and patents address aspects of supplier risk evaluation, but they do not disclose a unified, adaptive framework capable of integrating structured, unstructured, and real-time data for dynamic risk scoring.

U.S. Pat. No. 11,164,133 B2 describes a system for generating a Supplier Risk Index based on inherent risk ratings and predefined attributes, including financial and compliance data. While it allows for updates, it does not address real-time data integration or adaptive weighting of risk categories.

U.S. Pat. No. 11,392,875 B2 relates to a supply chain graph-based risk identification engine, evaluating risks through node criticality and propagation. This approach focuses on network-level visualization rather than supplier-specific predictive scoring using dynamic data sources.

U.S. Pat. No. 9,779,364 B1 discloses a machine learning-based procurement system that generates risk scores for suppliers and items based on historical and economic indicators. While it employs logistic regression and clustering algorithms to support procurement decisions, the system operates within predefined risk categories and lacks the capability to ingest and analyze real-time or unstructured data. Consequently, its responsiveness to dynamic supply chain conditions is limited.

Commercial tools, such as SAP Ariba Supplier Risk, provide third-party data integration and configurable risk frameworks. However, they typically operate with fixed scoring models and do not dynamically adjust to real-time events or unstructured data inputs such as news or social sentiment.

These prior systems address specific aspects of supplier risk management but do not teach or suggest a modular, adaptive system integrating structured, unstructured, and real-time data for dynamic, machine learning-based supplier risk evaluation.

### SUMMARY OF THE INVENTION

The present invention describes an adaptive supplier risk scoring system (ASRSS) that integrates data processing, dynamic risk categorization, and predictive scoring within a unified, context-aware framework. Unlike traditional static systems, the ASRSS evaluates supplier risks in real time, enabling adaptive responses to changing supply chain conditions and priorities.

The system ingests structured and unstructured data from diverse sources, including enterprise records, compliance logs, ESG (Environmental, Social, and Governance) ratings, surveys, and real-time feeds such as news and geopolitical events. These inputs are transformed into enriched supplier profiles, combining historical trends with real-time indicators to support multidimensional evaluations.

Machine learning models tailored to specific risk dimensions—such as financial stability, operational performance, cybersecurity, and ESG compliance—classify risks and generate predictive scores. Dimension-specific scores are aggregated into a unified overall score using dynamically weighted averages based on organizational context. Anomaly detection techniques further refine these evaluations to ensure accuracy and responsiveness.

The modular architecture supports configurable models tailored to industry, geographic, and organizational needs. Enriched supplier profiles and risk scores are stored in a centralized repository, providing real-time access for decision-making with traceable insights into evaluation methods and data sources. The system reduces manual effort and supports proactive risk management across industries including manufacturing, logistics, healthcare, and technology.

### BRIEF DESCRIPTION OF THE DRAWINGS

FIG. 1 illustrates the system architecture of the Adaptive Supplier Risk Scoring System (ASRSS), comprising the Data Integration Engine (DIE), Risk Categorization Engine (RCE), and Predictive Scoring System (PSS). These components interact through a centralized data pipeline to enable adaptive supplier risk evaluations.

FIG. 2 depicts the DIE, which transforms raw supplier data from various sources into structured, enriched profiles stored in the Supplier Data Repository. This process ensures data consistency and reliability for downstream analysis.

FIG. 3 illustrates an example output from the DIE, showing enriched supplier profiles with validated and normalized data from diverse structured, unstructured, and real-time sources, ready for downstream evaluation.

FIG. 4 shows the RCE, which classifies supplier risks across multiple dimensions using machine learning models. Contextual insights and anomaly detection ensure dynamic and accurate classifications.

FIG. 5 provides a detailed view of the Adaptive Risk Categorization module within the RCE. This module applies tailored machine learning algorithms to classify risks in dimensions such as financial, operational, ESG, and cybersecurity.

FIG. 6 is an example output from the RCE, detailing tagged risk dimensions, dynamic weights assigned through machine learning, and anomaly adjustments that refine supplier profiles for predictive scoring.

FIG. 7 depicts the PSS, which computes overall Supplier Risk Scores by aggregating risk dimensions with adaptive weighting. Scores are dynamically updated to reflect new data and anomalies.

FIG. 8 depicts an example output from the PSS, demonstrating calculated risk dimension scores, dynamic weighting, and the aggregation into a unified overall supplier risk score for decision-making.

FIG. 9 illustrates the process flow of the ASRSS, detailing the integration of the DIE, RCE, and PSS. It highlights continuous data flow from collection to scoring, enabling real-time supplier evaluations.

### DETAILED DESCRIPTION OF THE INVENTION

The invention integrates technically novel features that differentiate it from existing supplier evaluation systems. The Data Integration Engine (DIE) collects, validates, and normalizes data from structured, unstructured, and real-time sources, including financial metrics, compliance logs, questionnaires, news articles, and social media sentiment. Using advanced natural language processing (NLP) models and entity resolution techniques, the DIE creates enriched supplier profiles that integrate supplier-specific data with broader contextual insights.

The Risk Categorization Engine (RCE) dynamically classifies supplier risks across multiple dimensions, such as financial, operational, ESG compliance, and cybersecurity. By leveraging modular machine learning models, the RCE assigns risk categories based on supplier-specific and contextual factors while integrating anomaly detection to refine categorizations in real time. The system's context-sensitive tagging ensures that categorizations are tailored to organizational priorities and evolving data trends.

The Predictive Scoring System (PSS) calculates risk scores for individual dimensions and aggregates them into a comprehensive supplier risk score. This score leverages adaptive weighting, dynamically adjusted based on the supplier's tagged risk dimensions and organizational priorities. Predictive algorithms, such as gradient boosting machines (GBMs) and support vector machines (SVMs), evaluate patterns and trends, recalculating scores to reflect real-time supplier conditions.

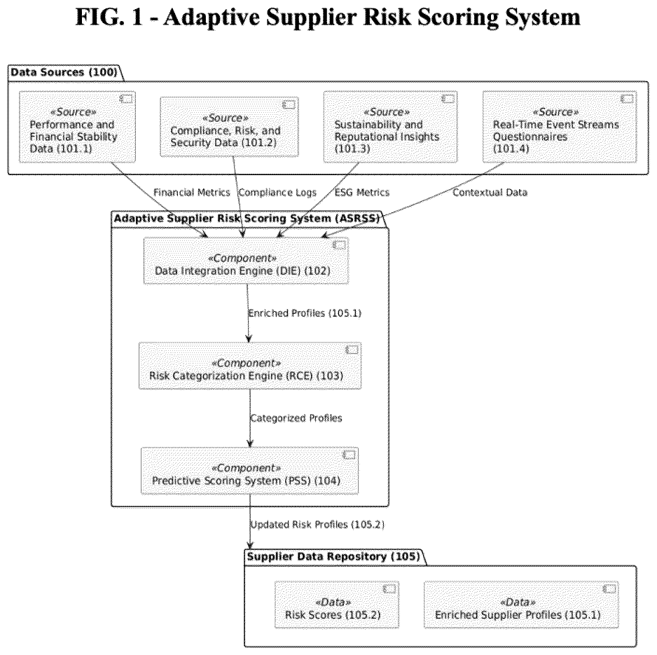

Together, these components form an adaptive, modular, and scalable framework for supplier risk evaluation, enabling precise, real-time, and context-aware assessments tailored to diverse operational, compliance, and industry-specific needs.

[SYSTEM ARCHITECTURE] The ASRSS integrates diverse data sources through three core components: the DIE, RCE, and PSS, enabling adaptive supplier risk evaluations, as illustrated in FIG. 1.

Data from Performance and Financial Stability (101.1), Compliance and Security (101.2), Sustainability and Reputation (101.3), Questionnaires and Real-Time Event Streams (101.4) is processed by the DIE (102) into Enriched Supplier Profiles (105.1) stored in the Supplier Data Repository (105). These profiles provide a comprehensive foundation for risk evaluation.

The RCE (103) categorizes risks across dimensions such as financial stability and ESG compliance using machine learning models tailored to each category. It dynamically refines classifications with anomaly detection to ensure accuracy and relevance.

The PSS (104) generates individual and composite risk scores dynamically updated to reflect real-time conditions. These scores, stored as Risk Scores (105.2), support actionable insights for procurement and risk management decisions.

This modular system is scalable, adaptable, and ensures context-aware supplier evaluations across industries.

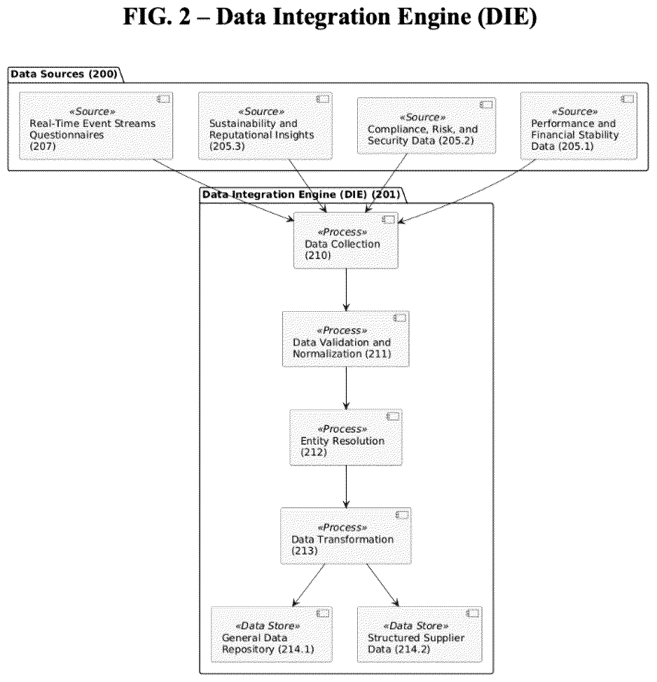

DATA INTEGRATION ENGINE (DIE): The DIE, as illustrated in FIG. 2, serves as a central component of the ASRSS. Its primary function is to aggregate, validate, normalize, and transform supplier-related data from a diverse array of sources into a unified format. By doing so, the DIE ensures seamless integration with downstream components such as the RCE and the PSS. Its event-triggered design allows for continuous updates, making the system adaptive to both historical and real-time data changes.

The DIE collects data from sources that include, but are not limited to, financial and performance data, compliance and security information, and sustainability and reputational insights. Financial and performance data (205.1), sourced from providers such as Dun & Bradstreet, RapidRatings, and Moody's, include metrics such as liquidity ratios, debt levels, credit scores, and supplier-reported KPIs. Compliance and security data (205.2) are drawn from databases like LexisNexis and Refinitiv World-Check, as well as cybersecurity ratings from providers like Bitsight and Resilinc. These datasets encompass regulatory adherence, sanctions, and technology risk assessments. Sustainability and reputational insights (205.3), including environmental, social, and governance (ESG) metrics, are sourced from platforms like EcoVadis and media monitoring tools such as LexisNexis. These inputs provide critical insights into a supplier's environmental impact, social practices, and reputational standing. Real-time event streams (207), such as news alerts, social sentiment data, and supplier questionnaires, supplement these sources with dynamic, contextual information.

The Data Collection module (210) aggregates data from these diverse sources, ensuring completeness and readiness for further processing. This module supports structured inputs, such as financial metrics and regulatory filings, as well as unstructured data, such as news articles and social media sentiment.

Once collected, the Data Validation and Normalization module (211) ensures data quality and consistency. Structured data undergoes schema conformity checks and missing-value reconciliation, while unstructured data is preprocessed to extract relevant attributes. For example, financial metrics may be normalized to a standard format, and text-based data may be parsed for keywords and sentiment using preprocessing algorithms. These steps ensure that all data, regardless of format, can be seamlessly integrated into downstream processes.

The Entity Resolution module (212) consolidates disparate records into unified supplier profiles. This process employs record-matching algorithms to link attributes such as supplier names, identifiers, and operational metrics. For unstructured data, natural language processing (NLP) techniques extract entities and map them to standardized fields. Models like BERT or SpaCy are utilized to identify and contextualize relationships within the data. Confidence scores are assigned to each resolved profile, reflecting the reliability of the resolution process and enabling transparency in supplier analysis.

The Data Transformation Pipelines (213) convert validated and resolved data into structured formats suitable for risk evaluation. This module ensures the hybrid schema can accommodate both structured and unstructured inputs. For example, declining financial metrics may be flagged as high-risk signals, while sentiment analysis of news articles may highlight reputational concerns. The transformation pipeline emphasizes preserving contextual relevance while prioritizing high-risk signals for subsequent analysis.

Processed data is stored in two distinct repositories: the General Data Repository (214.1) and the Structured Supplier Data Repository (214.2). The General Data Repository houses supplier-independent artifacts such as industry trends, regulatory information, and market benchmarks. The Structured Supplier Data Repository contains supplier-specific profiles enriched with links to general artifacts. This architecture ensures modularity and facilitates efficient querying, enabling the RCE and PSS to access relevant data for scoring and classification.

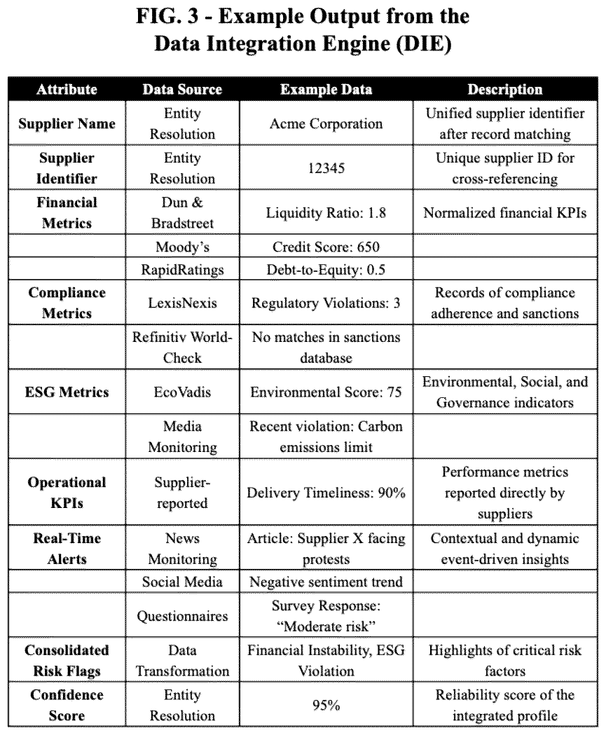

For example, as shown in FIG. 3, consider a supplier identified as financially unstable and facing ESG violations. Financial data from Moody's and compliance metrics from LexisNexis are aggregated, validated, and normalized into a unified profile. The profile is enriched with real-time news insights highlighting ESG violations and contextualized using industry benchmarks. Consolidated risk flags, such as “Financial Instability” and “ESG Violation,” are generated, with a confidence score assigned, supporting downstream risk scoring and comprehensive supplier evaluations.

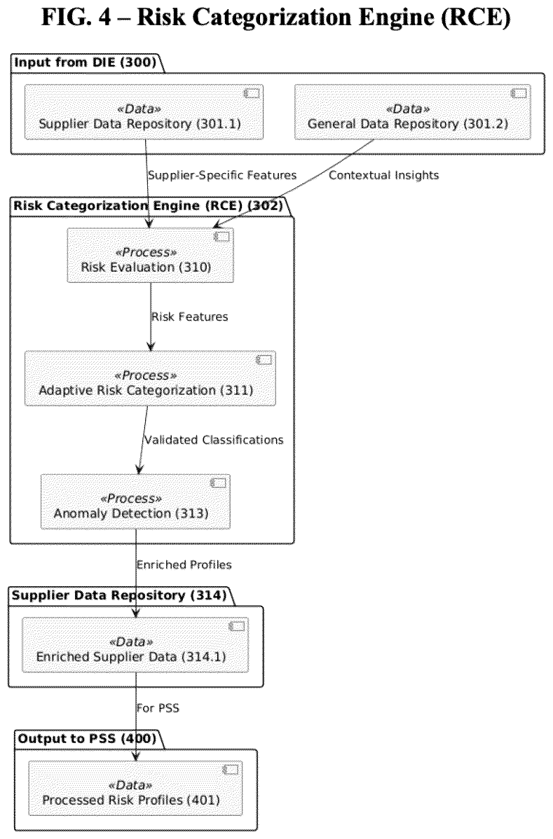

RISK CATEGORIZATION ENGINE (RCE): The RCE, as illustrated in FIG. 4, is a core component of the ASRSS, responsible for categorizing supplier risks and enriching supplier profiles with structured risk dimensions. These enriched profiles serve as critical inputs for the PSS, which computes overall risk scores. By leveraging machine learning (ML) models and integrating contextual insights, the RCE ensures precise, adaptive, and explainable supplier evaluations tailored to organizational, industry, and regional priorities.

The RCE begins with inputs from the DIE, specifically the Supplier Data Repository and the General Data Repository, which provide supplier-specific metrics and contextual industry data, respectively. These inputs include diverse data types, such as financial indicators, operational KPIs, ESG compliance metrics, cybersecurity reports, geopolitical risks, questionnaires, and sustainability factors. The Risk Evaluation module (310) processes and organizes this data into structured features that are ready for classification.

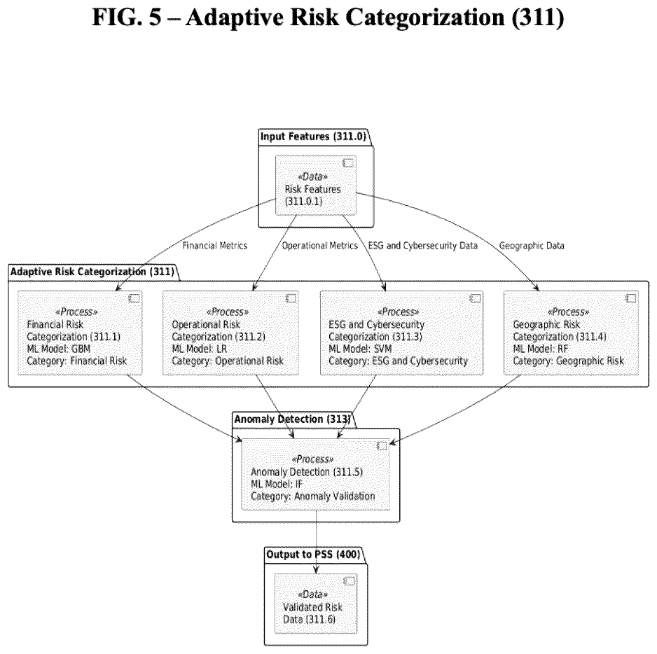

The Adaptive Risk Categorization module (311), as detailed in FIG. 5, applies a modular ML framework to assign risk categories to suppliers. Each risk dimension is processed using a preconfigured ML algorithm selected based on the unique characteristics of the data. For instance, Gradient Boosting Machines (GBMs) analyze financial stability by modeling relationships between metrics such as cash flow and regulatory compliance. Logistic Regression evaluates operational metrics by detecting patterns in delivery timelines and SLA adherence. Support Vector Machines (SVMs) classify ESG compliance and cybersecurity risks, leveraging high-dimensional, structured datasets for accuracy. Random Forest Classifiers handle geographic and sustainability risks by analyzing factors such as regional instability, environmental hazards, and emissions trends. These algorithms are chosen during system design to ensure that each risk dimension is evaluated with the most effective method.

The categorization process also incorporates contextual data from the General Data Repository to enhance classification accuracy. For example, geopolitical risks are evaluated with reference to real-time events, while ESG compliance is analyzed against industry benchmarks. This approach ensures that the risk categories are not only supplier-specific but also reflect broader market and regulatory conditions. Risk dimensions serve to highlight critical areas of concern for each supplier, allowing organizations to prioritize focus during evaluations. However, the absence of a tag does not imply that associated data is ignored; rather, it indicates that other dimensions take precedence given organizational priorities or contextual considerations.

Once categorized, each supplier profile is tagged with applicable risk dimensions and weighted based on organizational priorities and regional relevance. These weights, informed by classification predictions, prioritize the most significant risks for the organization's decision-making processes. The Anomaly Detection module (313) refines these tags by identifying irregularities in supplier behavior. For example, Isolation Forests detect unexpected events such as sudden financial instability, delivery delays, or cybersecurity breaches. Detected anomalies trigger updates to the risk categories, ensuring the profiles remain accurate and reflective of current conditions.

The enriched supplier profiles are stored in the Supplier Data Repository. These profiles include a unique supplier ID, the assigned risk categories, anomaly details, timestamps, and links to relevant contextual data. This unified repository serves as the single source of truth for the PSS, which utilizes the enriched profiles to compute tailored risk scores. By consolidating all risk-related data within the Supplier Data Repository, the system avoids redundancy and maintains a streamlined architecture.

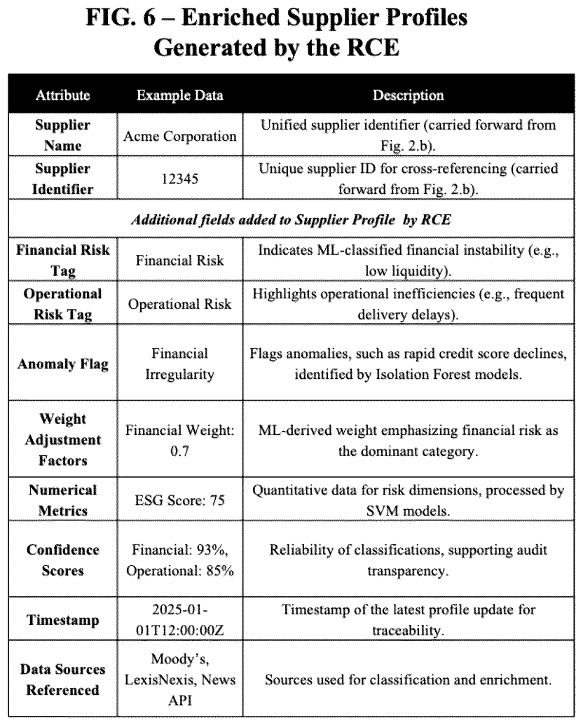

For example, as illustrated in FIG. 6, a supplier with declining financial performance, frequent delivery delays, and ESG compliance violations might be tagged with “Financial Risk,” “Operational Risk,” and “Sustainability Risk” using GBMs and other tailored machine learning models. Anomalies, such as unexpected spikes in delivery delays, are flagged, while timestamps, contextual data links, and classification methods trace the origins of each tag. These enriched profiles, stored in a centralized repository, enhance traceability, transparency, and accountability for downstream use by the PSS, ensuring stakeholders can audit and verify classifications and scores with confidence.

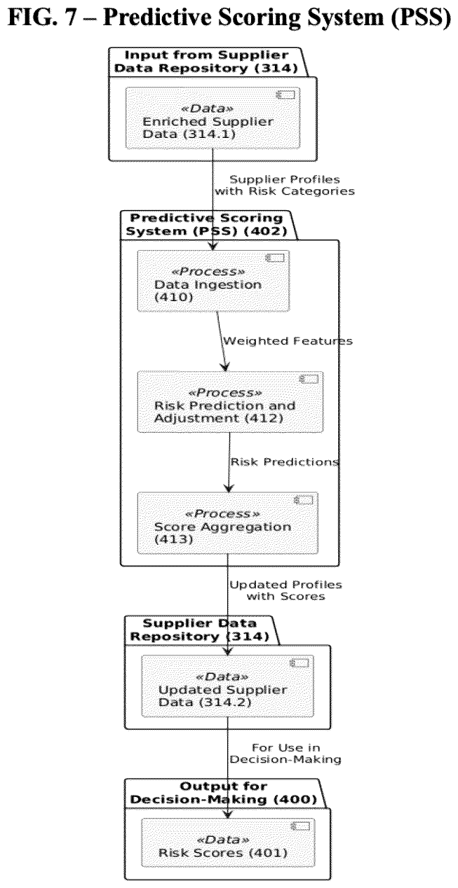

PREDICTIVE SCORING SYSTEM (PSS): The PSS, as depicted in FIG. 7, is responsible for calculating comprehensive Supplier Risk Scores by analyzing enriched supplier profiles and risk dimensions generated by the RCE. The PSS integrates machine learning models and statistical methods to predict risks across multiple dimensions and aggregates these predictions into a unified supplier risk score. These scores are dynamically updated, ensuring that they reflect current supplier conditions and contextual industry trends.

The process begins with the ingestion of enriched supplier profiles from the Supplier Data Repository (314.1), which includes supplier-specific features, assigned risk categories, anomaly tags, and contextual data links. The Data Ingestion module (410) extracts relevant attributes for analysis, such as financial metrics, operational KPIs, compliance history, ESG performance, and geopolitical factors. This module ensures that all necessary features are formatted and prepared for subsequent processing.

The Risk Prediction and Adjustment module (412) applies machine learning models tailored to specific risk dimensions to predict the likelihood of adverse outcomes. For example, Gradient Boosting Machines (GBMs) are used to model complex interactions between financial metrics, such as cash flow trends and regulatory compliance, to predict financial instability. Support Vector Machines (SVMs) are applied to classify high-dimensional datasets, such as ESG compliance and cybersecurity risks, leveraging structured and semi-structured data for precise classifications. Simpler predictive tasks, such as binary classifications (e.g., compliant vs. non-compliant), are addressed using logistic regression models. For dimensions influenced by historical trends, Long Short-Term Memory (LSTM) networks analyze temporal patterns to predict future risks, such as potential delivery disruptions.

Each risk dimension is scored on a 1-100 scale, representing the predicted risk level for that specific category. For instance, a supplier's financial risk score might be 85, indicating a high likelihood of financial instability, while their operational risk score could be 70, reflecting moderate performance issues. Anomaly detection techniques, such as Isolation Forests, are also integrated within this module to refine predictions by identifying irregular patterns, such as sudden changes in financial metrics or unexpected operational disruptions.

The Score Aggregation module (413) combines individual category scores into a unified supplier risk score. Aggregation is performed using dynamic weighted averages, where each dimension is assigned a weight based on its relevance to the organization's strategic priorities and the specific tagged risk dimensions for each supplier. For example, a supplier tagged with “Financial” and “ESG” risks may have those dimensions weighted more heavily compared to untagged ones, ensuring a context-sensitive, tailored scoring approach. This dynamic adjustment eliminates the need for rigid, rule-based systems, making the scoring process more responsive to diverse risk profiles while maintaining accuracy.

The resulting supplier risk scores are stored back in the Supplier Data Repository (314.2), enriching the supplier profiles with computed risk scores, timestamps, and confidence levels. This centralized storage allows the PSS to integrate seamlessly with downstream decision-making systems. The final scores, represented in FIG. 7 as Risk Scores (401), are formatted for real-time queries or batch analysis, enabling procurement teams and risk managers to make data-driven decisions based on current and comprehensive supplier evaluations.

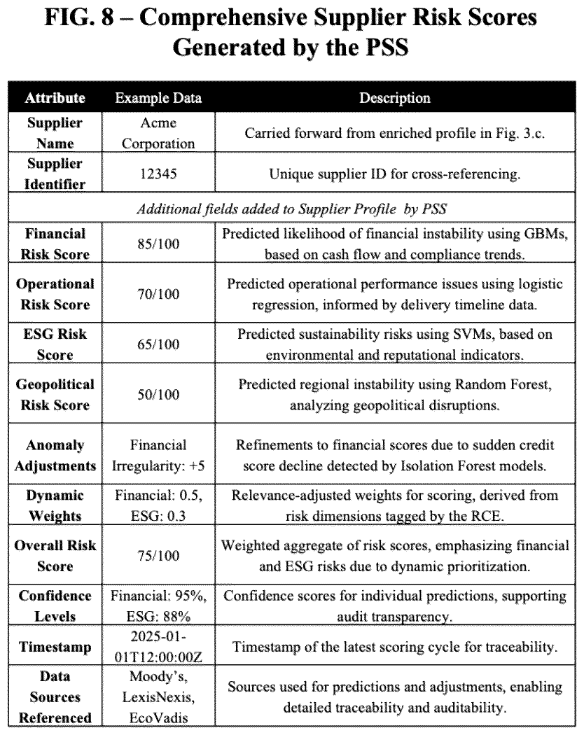

For example, as depicted in FIG. 8, the PSS evaluated Acme Corporation's risk dimensions based on enriched profiles from the RCE. Financial risks were assigned a score of 85/100 by GBMs analyzing cash flow trends and compliance data. Operational and ESG risks were scored at 70/100 and 65/100, respectively, by logistic regression and SVM models. The final risk score of 75/100 was derived by weighting financial and ESG risks more heavily, per RCE-tagged priorities. Confidence levels and data sources enhance transparency, supporting auditability and downstream decision-making.

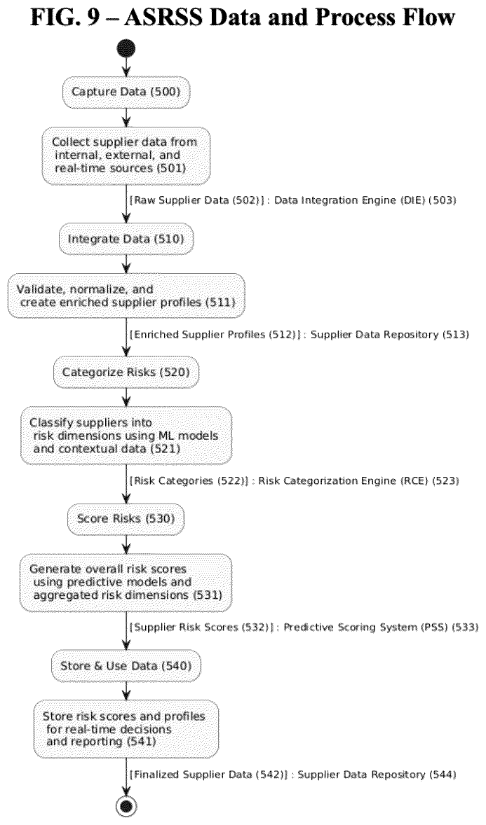

FLOW AND INTERACTIONS: FIG. 9 illustrates the data and process flow of the ASRSS, which integrates data processing, risk categorization, and scoring to produce actionable supplier evaluations. The system comprises five primary phases, each contributing to the generation of supplier risk scores and enriched profiles.

The process begins with data capture, where supplier information is collected from diverse sources, including internal databases, external providers, and real-time feeds. This phase ensures a comprehensive view of supplier performance, risks, and trends. Examples of data sources include financial metrics from providers like Dun & Bradstreet, regulatory compliance records from LexisNexis, and real-time alerts from news monitoring tools. The collected raw data serves as the foundation for further processing.

In the data integration phase, the Data Integration Engine (DIE) validates, normalizes, and transforms the raw data into structured and enriched supplier profiles. This step ensures data consistency and reliability, resolving discrepancies and enhancing the profiles with contextual links to broader industry and regulatory trends. These enriched profiles are stored in the Supplier Data Repository (314), providing a centralized resource for subsequent analysis.

The next phase involves risk categorization, where the Risk Categorization Engine (RCE) dynamically evaluates supplier profiles to classify risks across dimensions such as financial stability, operational performance, ESG compliance, and cybersecurity vulnerabilities. By leveraging modular machine learning models tailored to each dimension, the RCE applies context-sensitive tagging to identify relevant risk dimensions for each supplier. For instance, geopolitical risks are classified with reference to real-time events, while financial risks are categorized using predictive insights into cash flow and compliance metrics. The RCE anomaly detection module refines these classifications by identifying irregular patterns, such as sudden financial instability or operational disruptions. This ensures that risk categorizations remain accurate and reflect current supplier conditions. These categorized profiles are stored and made available to subsequent processes in the Supplier Data Repository (314.1).

The risk scoring phase employs the Predictive Scoring System (PSS) to generate overall risk scores for each supplier. Using predictive models, anomaly detection techniques, and aggregated risk dimensions, the PSS produces scores that quantify supplier risks on a scale of 1 to 100. Importantly, the PSS dynamically adjusts scoring weights based on risk dimensions tagged by the RCE, ensuring that scores reflect organizational priorities and supplier-specific conditions. For example, compliance risks may carry higher weights in regulated industries, while operational performance may dominate in logistics-focused sectors. The dynamically updated scores ensure real-time accuracy and relevance, enabling comprehensive risk quantification.

In the final phase, the enriched profiles and risk scores are stored back in the Supplier Data Repository (314.2), where they can be accessed for decision-making, reporting, and procurement evaluations. This centralized repository serves as the central hub for all supplier-related risk data, enabling stakeholders to query and analyze supplier risks in real time.

This integrated flow ensures that supplier risk evaluations remain adaptive, comprehensive, and actionable, supporting organizations in mitigating risks and optimizing supplier relationships. The modular design of the ASRSS allows for scalability and customization, ensuring its applicability across diverse industries and use cases.

### DEFINITION OF TERMS

Supplier Profile: A structured dataset representing a supplier's characteristics, including financial, operational, compliance, and contextual metrics, enriched with data from structured, unstructured, and real-time sources.
Risk Dimension: A specific category of risk relevant to supplier evaluation, such as financial stability, operational performance, compliance adherence, ESG compliance, cybersecurity, or geopolitical exposure.
Enriched Supplier Profiles: Supplier profiles enhanced with contextual insights, including derived metrics, historical trends, and real-time data, stored in the Supplier Data Repository.
Structured Data: Data that is organized in a predefined format, such as financial statements, compliance certificates, or operational logs.
Unstructured Data: Data without a predefined format, including textual data from news articles, social media sentiment, and survey responses.
Real-Time Data: Data that is continuously updated to reflect current conditions, such as live feeds from geopolitical event trackers or real-time compliance alerts.
Machine Learning (ML) Models: Algorithms used to analyze and predict supplier risks, including Gradient Boosting Machines (GBMs), Support Vector Machines (SVMs), and Logistic Regression, tailored to specific risk dimensions.
Anomaly Detection: Techniques employed to identify irregular patterns or outliers in data, such as unexpected changes in supplier performance metrics or compliance violations.
Weighted Risk Score: A composite supplier risk score derived from individual risk dimension scores, calculated using weighted averages to prioritize critical risks.
Contextual Insights: Additional data or analysis that enhances the understanding of supplier risks, such as industry benchmarks, geographic trends, or regulatory conditions.
Dynamic Risk Evaluation: A process of recalibrating risk profiles and scores based on real-time updates, ensuring the system adapts to evolving conditions.
Predictive Scoring System (PSS): A component of the ASRSS responsible for generating and updating supplier risk scores through predictive models and aggregated risk dimensions.
Risk Categorization Engine (RCE): A component of the ASRSS that classifies supplier risks into structured dimensions using machine learning models and contextual insights.
Data Integration Engine (DIE): A component of the ASRSS that collects, validates, normalizes, and enriches supplier data from diverse sources.
Adaptive Supplier Risk Scoring System (ASRSS): A modular system combining the DIE, RCE, and PSS to provide real-time, adaptive supplier risk evaluations. It integrates diverse data, dynamically categorizes risks, and computes predictive scores using machine learning and contextual insights.

What is claimed is:

1. An adaptive supplier risk evaluation system comprising:
a processing framework configured to aggregate and transform data from structured, unstructured, and real-time sources into enriched supplier profiles;
a categorization framework configured to classify suppliers into dynamic risk profiles across multiple dimensions, wherein said profiles are dynamically refined based on new data inputs or contextual shifts; and
a scoring framework configured to generate and dynamically update risk scores for each supplier based on evolving data and conditions.

2. The system of claim 1, wherein the processing framework aggregates data from sources comprising financial metrics, compliance records, operational indicators, environmental, social, and governance (ESG) ratings, questionnaires, surveys, and real-time event streams.

3. The system of claim 1, wherein the categorization framework classifies supplier risks across dimensions comprising financial stability, compliance adherence, operational performance, geographic exposure, cybersecurity vulnerabilities, and sustainability compliance.

4. The system of claim 1, wherein the categorization and scoring frameworks employ machine learning techniques to dynamically classify, compute, and refine supplier risk profiles and scores, including predictive modeling, anomaly detection, and contextual recalibration.

5. The system of claim 1, wherein the scoring framework aggregates risk scores across dimensions using weighted averages and dynamically adjusts weights based on organizational priorities and contextual data.

6. The system of claim 1, wherein the supplier profiles and risk scores are auditable and explainable, providing traceable insights into the methodologies and data sources used for evaluations, and are stored in a centralized repository to enable real-time queries and decision-making.

7. The system of claim 1, wherein risk evaluations leverage tailored machine learning models and contextual insights, including industry benchmarks, market conditions, and real-time geopolitical events, to refine and dynamically update supplier risk profiles and scores.

8. The system of claim 1, wherein the modular architecture is configurable to adapt evaluation criteria based on industry, geography, and organizational priorities, enabling tailored risk assessments.

9. A method for adaptive supplier risk evaluation comprising:
aggregating structured, unstructured, and real-time data into enriched supplier profiles;
classifying suppliers into dynamic risk profiles using machine learning models tailored to specific dimensions; and
generating and dynamically updating supplier risk scores using predictive models, anomaly detection, and contextual adjustments based on evolving supplier metrics.

10. The method of claim 9, wherein the aggregation includes reconciling inconsistencies across structured and unstructured data sources and normalizing the data into unified formats.

11. The method of claim 9, wherein classification models are selected and applied based on the unique characteristics of the risk dimension, comprising machine learning algorithms for predictive insights, segmentation, and anomaly detection.

12. The method of claim 9, wherein dynamic updates to risk profiles and scores are triggered by new data inputs, anomalies, or detected contextual changes to maintain real-time accuracy and relevance.
